(19) United States
(12) Patent Application Publication
(10) Pub. No.: US 2017/0310765 A1
(43) Pub. Date: Oct. 26, 2017

(54) SYSTEM AND METHOD FOR LOCATION-BASED ACCESS TO DOCUMENT PROCESSING DEVICES

(71) Applicants: Kabushiki Kaisha Toshiba, Minato-ku (JP); Toshiba TEC Kabushiki Kaisha, Shinagawa-ku (JP)

(72) Inventors: Michael L. Yeung, Mission Viejo, CA (US); Marianne L. Kodimer, Huntington Beach, CA (US); Jenny Zhang, Irvine, CA (US)

(21) Appl. No.: 15/134,006

(22) Filed: Apr. 20, 2016

(51) Int. Cl. H04L 29/08; H04W 4/02; H04L 12/24

(52) U.S. Cl. CPC H04L 67/16; H04L 41/0681; H04W 4/025

(57) ABSTRACT

A system and method for location-based document processing device selection includes a device including a processor, memory and a network interface. The device is configured for data communication with a plurality of identifiable multifunction peripherals. The memory stores contact data mapping each multifunction peripheral to at least one designated contact. The device is further configured to receive status data from each of the multifunction peripherals and to store received status data in the memory. An analytical engine calculates list data from stored status data. The device selectively generates alerts corresponding to identified multifunction peripherals in accordance with an analysis of the list data. The device communicates the alerts to at least one designated contact in accordance with each identified multifunction peripheral and the contact data. The system thus supplies users, such as print users or service technicians, listings or mappings of proximate devices for use or servicing.

### TECHNICAL FIELD

This application relates generally to geolocation in conjunction with document processing devices. The application relates more specifically to use and servicing of document processing devices in accordance with relative locations of portable computing devices.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. Until more recent times, users, which may include individuals or groups such as employees, administrators or technicians administrators of networked MFPs, were also generally in relatively fixed location. A user would typically communicate documents or other information from his or her office or workstation. An administrator or technician would also monitor devices from a workstation.

Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. If multiple users send their requests to the same device, the jobs are queued and outputted sequentially.

User devices have become increasingly mobile. Often times users interact with MFPs via portable notebook computers, or via handheld devices such as tablet computers, smartphones, or the like. While many portable devices may still be used at a workplace, a user may do so from various workplace locations. Many users will interact with networked MFPs while travelling or from home. While a fixed user in a stable MFP setting may quickly realize an optimal MFP utilization, mobile users, administrators or technicians may not even be aware of what MFP resources are around them.

### SUMMARY

In accordance with an example embodiment of the subject application, a system and method for location-based device selection includes a device including a processor, memory and a network interface. The device is configured for data communication with a plurality of identifiable multifunction peripherals. The memory stores contact data mapping each multifunction peripheral to at least one designated contact. The device is further configured to receive status data from each of the multifunction peripherals and to store received status data in the memory. An analytical engine calculates list data from stored status data. The device selectively generates alerts corresponding to identified multifunction peripherals in accordance with an analysis of the list data. The device communicates the alerts to at least one designated contact in accordance with each identified multifunction peripheral and the contact data.

### BRIEF DESCRIPTION OF THE DRAWINGS

Various embodiments will become better understood with regard to the following description, appended claims and accompanying drawings wherein:

FIG. 1 an example embodiment of a geolocation service network for document processing devices;

FIG. 2 is an example embodiment of a document rendering system;

FIG. 3 is an example embodiment of a of digital devices such as tablet computer;

FIG. 4 is an example embodiment of a location based document processing system;

FIG. 5 is an example embodiment of a user device during operation;

FIG. 6 is an example embodiment of a flowchart for a user device location operation;

FIG. 7 is an example embodiment of a flowchart for use of geolocation information to assist in sorting or prioritizing device servicing;

FIG. 8 is an example embodiment of a technician device user interface; and

FIG. 9 is an example embodiment of a mapping output associated with locations of document processing devices.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

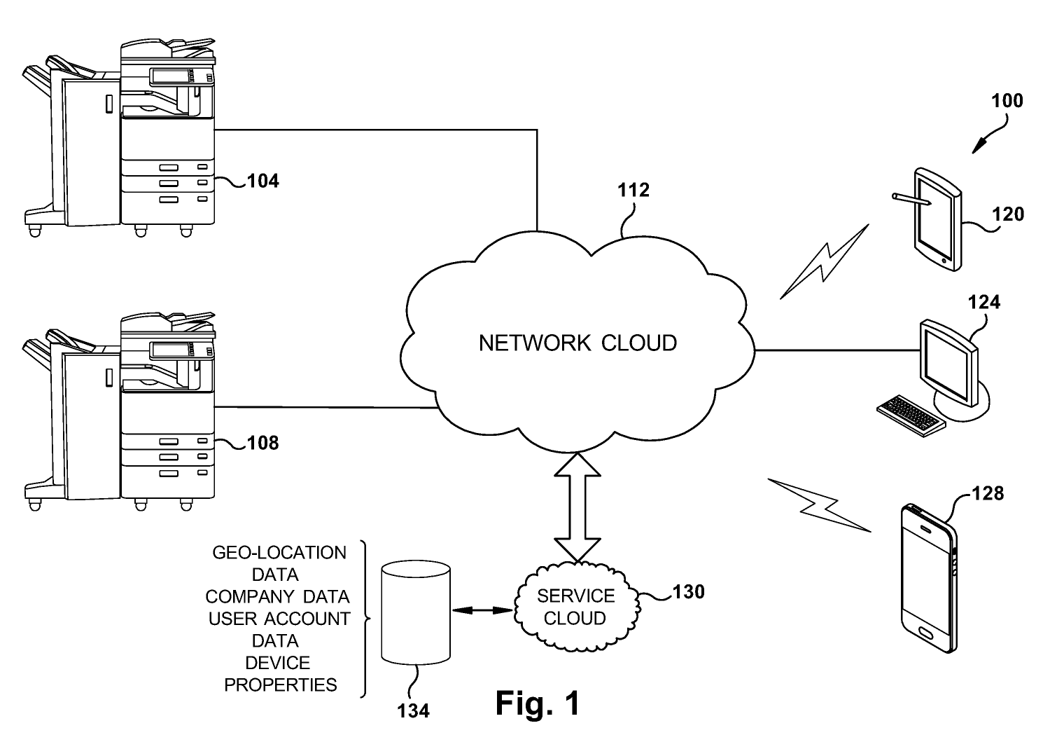

In accordance with the subject application, FIG. 1 illustrates an example embodiment of a geolocation service network 100 for document processing devices. Two or more document processing devices, illustrated by MFP 104 and MFP 108 in the example, are in network communication with network cloud 112. Network cloud 112 is comprised of any suitable local area network (LAN) or wide area network (WAN), alone or in combination, and which may include the Internet. Also in data communication with network cloud 112 are user data devices, such as tablet computer 120, workstation 124 and smartphone 128. Suitable architecture for such data processing devices will be detailed below.

Service cloud 130 is associated with network cloud 112, and includes processing and storage functionality via data storage 134. As will be discussed further below, service cloud 130 obtains stores and processes information about MFPs and user devices, including device identity, device properties, device status, user account data and device location data. Service cloud 130 functions to associate users and their associated data devices with one or more MFPs for use, monitoring or servicing.

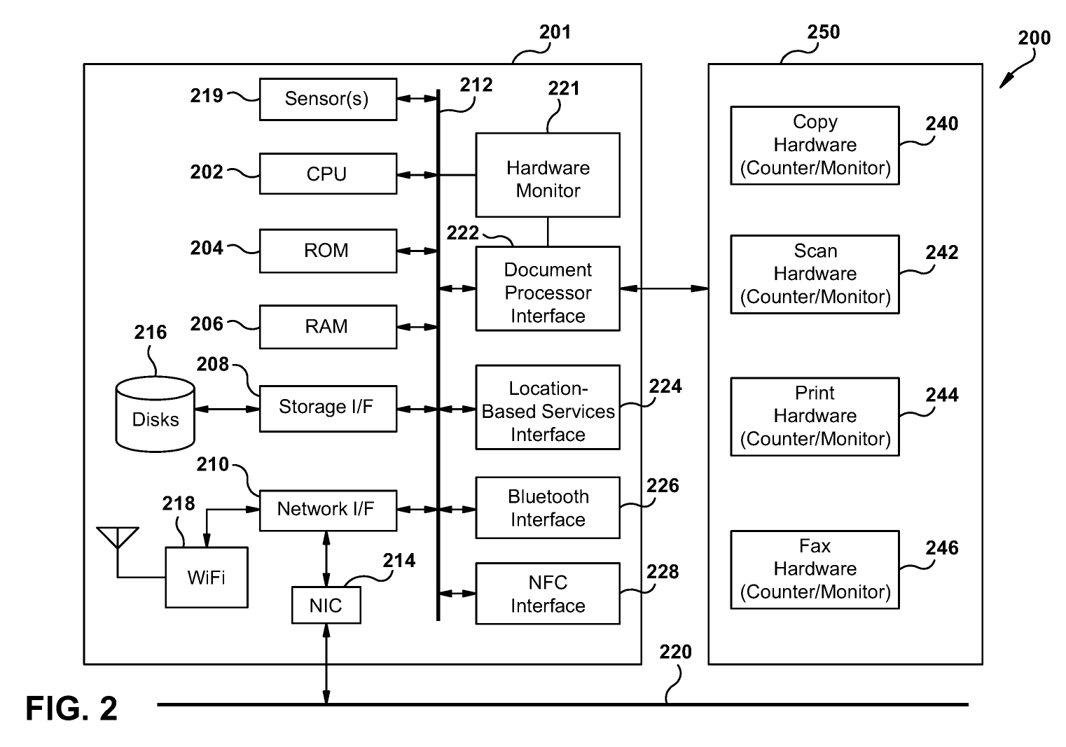

Turning now to FIG. 2, illustrated is an example embodiment of a document rendering system 200 suitably comprised within an MFP, such as with MFPs 104 and 108 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 can also be in data communication with BLUETOOTH interface 226, and NFC interface 228, either directly as shown or through network interface 218 (not shown.) Processor 202 is also in data communication with one or more sensors 219 which provide data relative to a state of the device or associated surroundings, such as device temperature, ambient temperature, humidity, device movement and the like.

Processor 202 can also be in data communication with any suitable user input/output (I/O) interface which provides data communication with user peripherals, such as displays, keyboards, mice, track balls, touch screens, or the like. Hardware monitor 221 suitably provides device event data, working in concert with suitably monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Additional interfaces are suitably provided within controller 201 include a location-based services (LBS) interface 224. Data relative to device location is suitably channeled to controller 201 vial LBS interface 224 from any suitable location system. By way of example, location may be determined by Global Positioning System (GPS) information, cellular location information or network location information, or a combination thereof. Location information is also suitably determined outside of the MFP, such as by a technician who inputs device location information directly to the device.

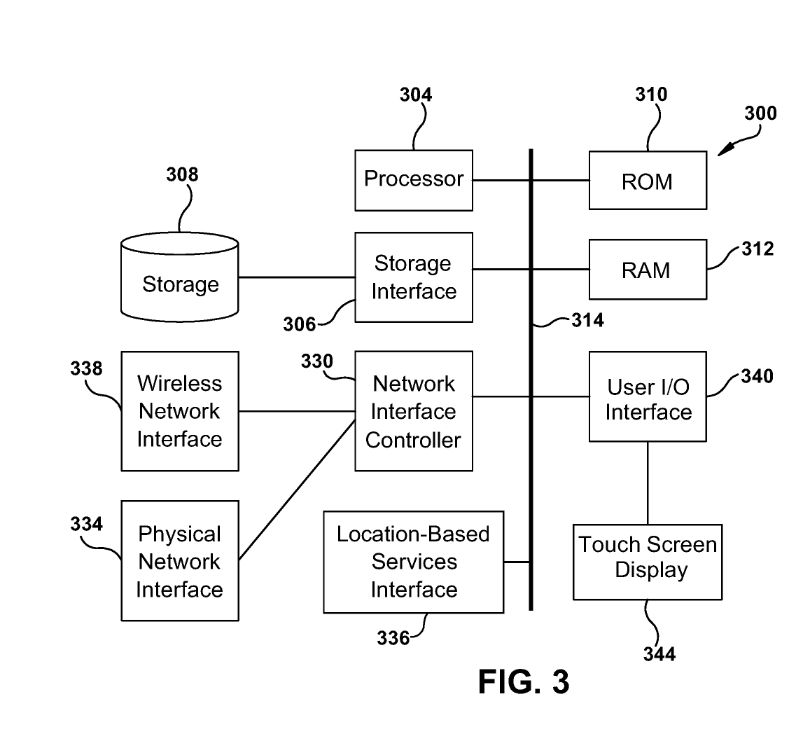

Turning now to FIG. 3, illustrated is an example embodiment of digital devices such as tablet computer 120, workstation and smartphone 128, as well as constituents of service cloud 130 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above. The system suitably uses LBS services interface 336, such as those described above. By way of example, if multiple error event management systems are used, it may be advantageous to have monitoring of devices completed by a local or more proximate event management system.

Processor 304 is also in data communication with a user input/output (I/O) interface 340 which provides data communication with user peripherals, such as display 344, as well as keyboards, mice, track balls, touch screens, or the like. It will be understood that functional units are suitably comprised of intelligent units, including any suitable hardware or software platform.

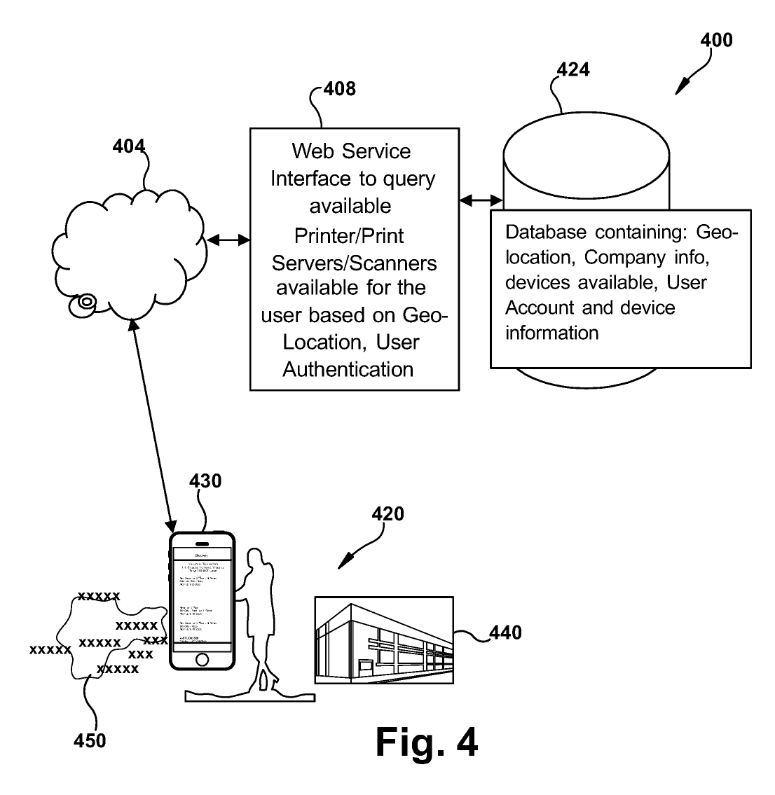

Referring now to FIG. 4, illustrated in an example embodiment of a location based document processing system 400. Service cloud 404 includes a web service interface 408 which functions to query available MFPs based on their location relative to a user 420 and their associated data device 430. Service cloud 408 is associated with a database 424 including geo-location information for users, as well as MFPs, along with company, user and device information. Device location may be determined by Global Positioning System (GPS) information, cellular location information or network location information, or a combination thereof. Location information is also suitably determined outside of a device, such as by a technician who inputs device location information directly.

In the example embodiment of FIG. 4, a user data device 430 suitably provides its location and user credentials or other identification to the service cloud 404. The service cloud 404, in turn, reviews available MFPs, particularly nearby MFPs, and relays relevant data regarding them to the user data device 430. The service cloud 404 may also determine available devices relative to any constraints placed against the user or user affiliation, such as number of pages that they may print, whether they can print in color, or whether they are constrained to a set of available MFPs based lower cost services being offered. The service cloud 404 may also provide cost information to the user or their company for approval. The service cloud 404 may also function to debit or charge for its services, as well as services for devices selected for processing of documents.

Service cloud 404 facilitates geolocation based device presentation and selection without a need for device discovery to be completed by the user data devices 430 themselves. It will be appreciated that may devices in simultaneous operation would result in duplicative communications and additional data traffic if they were to poll for available devices themselves along with relevant device information. In the example of FIG. 4, a user 420 and their associated data device 430 is associated with a company 440 and a location 450, which is suitably depicted on a map image as will be described in further detail below.

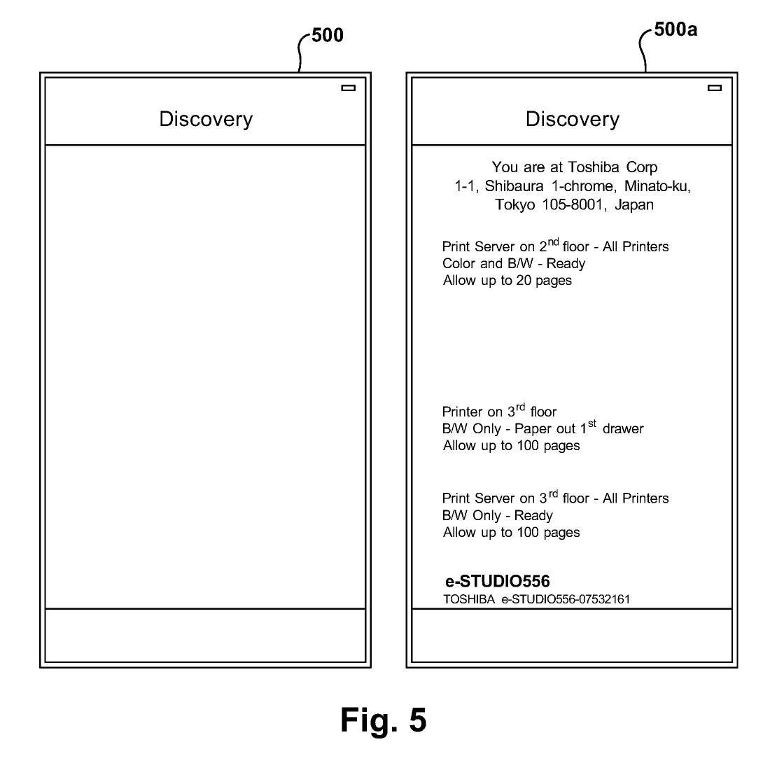

FIG. 5 illustrates an example embodiment of user data device 430 during operation. Device interface 500, suitably a touchscreen, commences a data communication with a service cloud when prompted by the user. Illustrated is an example embodiment of a populated user device interface 500a which depicts a listing of suitable MPFs or other document processing devices. As noted above, such listing may be generated by relative location, device capabilities, user constraints, cost, company directive and the like.

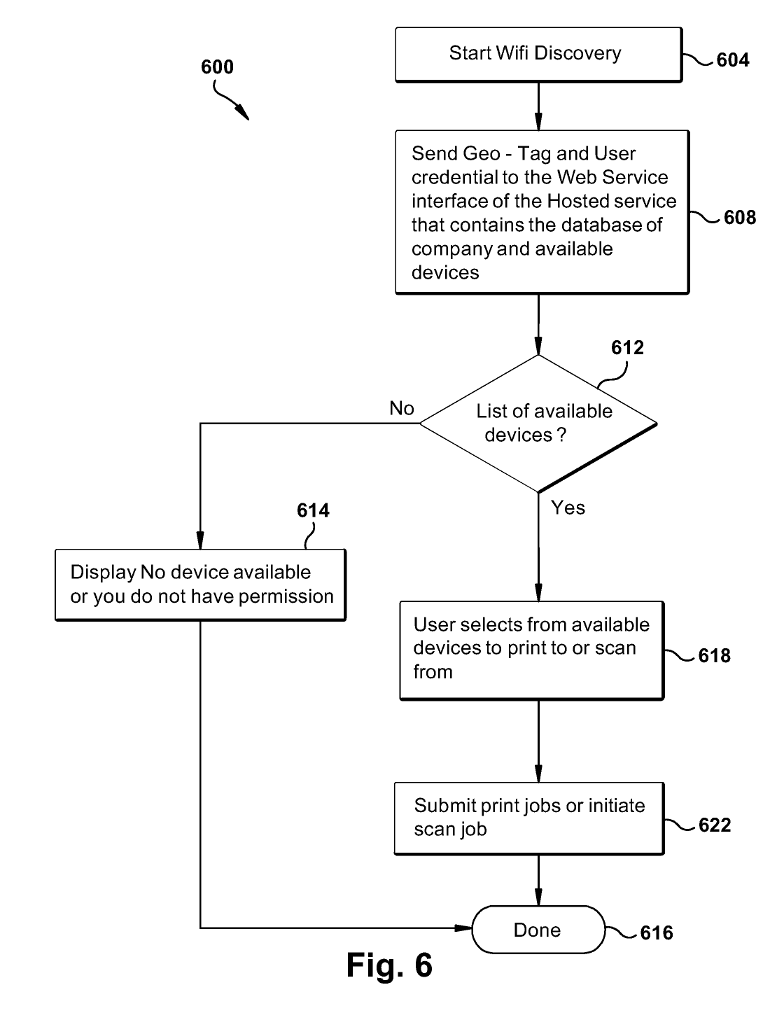

FIG. 6 is an example embodiment of a flowchart 600 for a user device location operation. The process commences at block 604 when a user commences a query operation on their device. Next, at block 608, user credentials and location information are communicated to the service cloud where networked devices are determined as detailed above. A determination is made at block 612 as to whether any devices are available to the user. If there are no available devices for the user, the user is notified at block 614 and the procedure is complete, subject to another attempt by the user should their location change or other selection criteria be modified. The procedure ends at block 616.

If devices are available as determined at block 612, the devices are communicated to the user's device and the user selects one or more devices from the list at block 618. The user then submits document processing instructions at block 622, which may include submission of local or network-based electronic document for processing, or instructions for another document processing operation on the selected MFP, such as a faxing operation. Next, the procedure ends at block 616.

As noted above, use of geolocation information from a user device, particularly a portable user device, provides for job submissions as well as device servicing. MFPs require periodic maintenance for reasons including device failure or depletion of supplies such as paper, toner, ink or staples. While some maintenance procedures are straightforward, many are complex and require the services of a trained technician. When devices are distributed among different locations, monitoring or maintenance can require significant resources, and having a dedicated technician may not be justifiable or cost effective.

Companies may outsource device maintenance to a service company. Service technicians can be notified by the company when maintenance is required. More recently, devices are networked and include an ability to send an alert message, such as an e-mail, to a technician charge with maintaining a device when service is required. Service may be due to things such as device failure, but may also include regularly scheduled maintenance intervals. Such intervals may be based on time passage, or may be based on machine usage, such as number of copies made. Many devices include counters or other gauges which may communicate status information via an associated network.

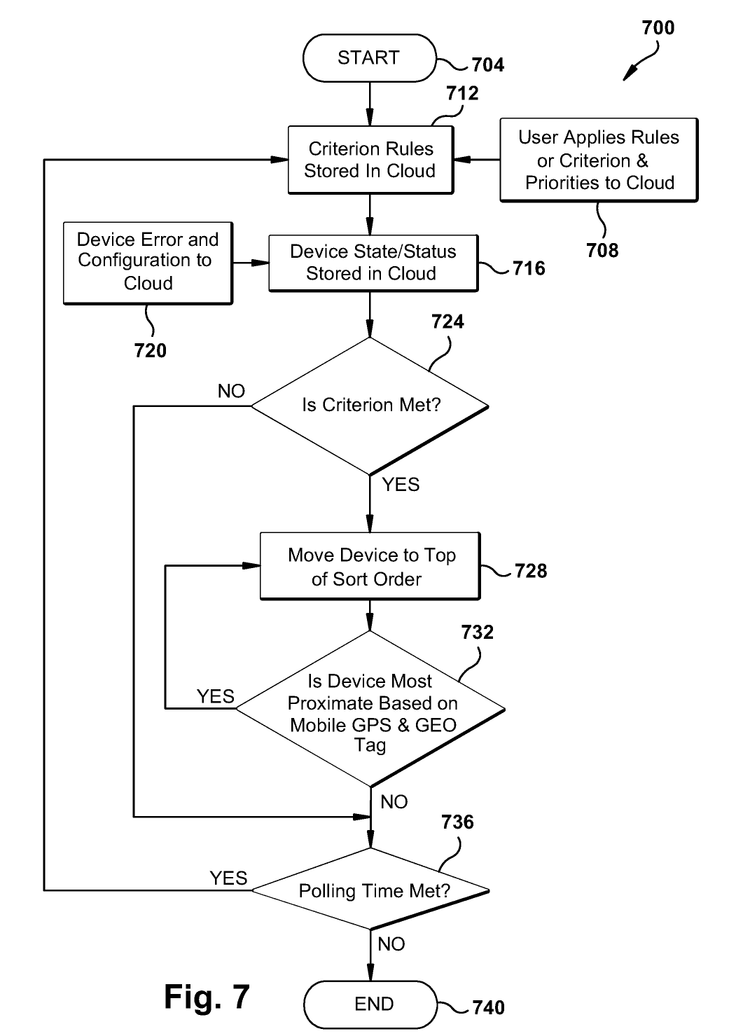

It is highly desirable for service technicians to be as efficient as possible. Device outages can lead to lost productivity. Increased efficiency allows for more responsive servicing, and maximizes technician utilization. FIG. 7 provides an example embodiment of a flowchart 700 for use of geolocation information to assist in sorting or prioritizing device servicing. The process commences at block 704 wherein a mobile technician is in communication with a cloud service. Criterion or rules for device list ordering are provided in block 712. Such information is suitably obtained in advance, for example as shown in block 708 through user applied rules, criteria, and priorities that are stored with the cloud service. Status or states of monitored devices are stored in the cloud at block 716 and suitably input by polling or broadcasting of device information by MFPs. By way of example, as shown in block 720 stored information may be input to the cloud service based on device distance, device clustering, device errors, error severity, available parts inventory, time of day, technician status, technician capability, or any other suitable criterion.

Next, a determination is made as to whether established criteria for a technician or a device are met at block 724. If so, a device is moved upward in a sort order of devices at block 728. A determination is made at block 732 as to whether the subject device is proximate to the technician. If so, that device is moved upward in the list. This is suitably completed for all devices or a subset of devices. The ordering of devices in the list may be periodically updated with additional geolocation information as a technician moves from device site to device site. In the illustrated example, a polling interval is checked made at block 736. If it is not time to poll the devices and update the listing, the process ends at block 740. If so, the process returns to block 712 and repeats the process as detailed above.

While the a description in the example above is in connection with device servicing, it will be appreciated that ordering of devices is also suitable for users to list hierarchically suitable devices.

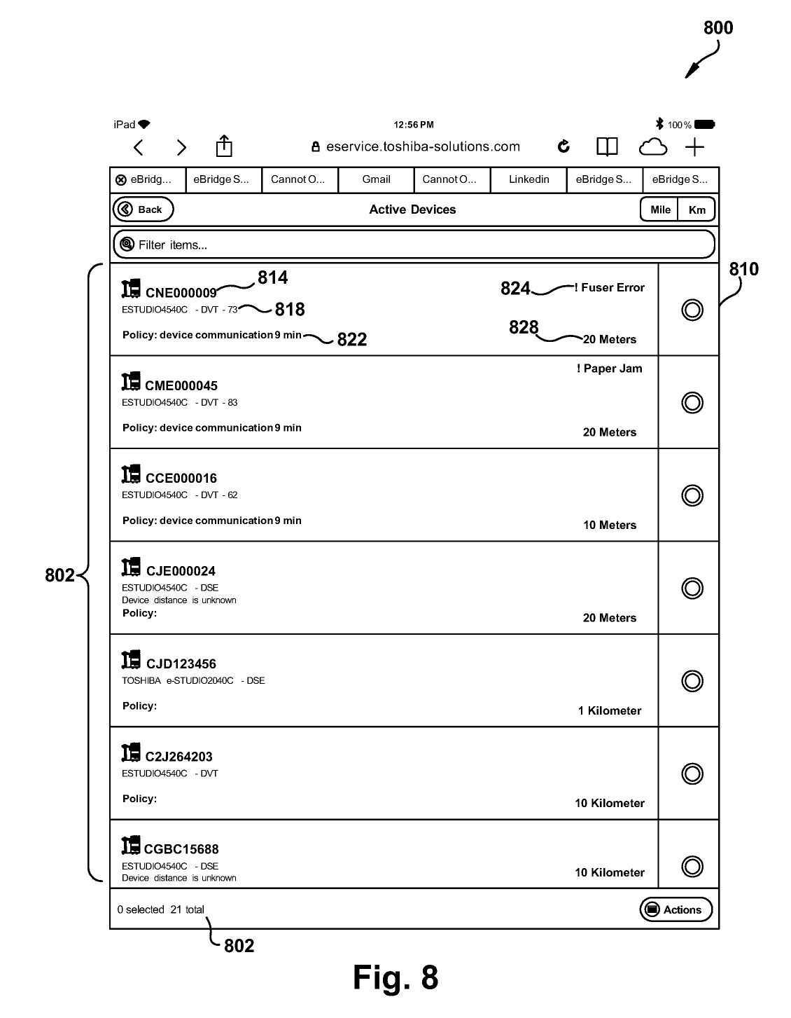

FIG. 8 illustrates an example embodiment of a technician or other device user interface 800 of a portable device. In the illustrated example, a technician is provided on the portable device with an ordered list of prioritized devices for use, such as servicing. In the example, a set of 21 devices is presented as identified at 802. Seven device listings are viewable at once in the illustrated example. Device 810 is ordered at the top of the list and thus of current, highest priority for servicing. As illustrated with device 810, in the example embodiment, each device listing includes a device identifier 814, a device type indicator 818 and a policy indicator 822. Also included in the listing is an error type 824 and a distance between the portable device and the unit at 828. Thus, it will be understood that a technician is provided with an updated listing of devices for servicing. It will be understood further that listings for each technician are generated in accordance with particular information associated with a technician, which information is stored in the service cloud.

In an embodiment, the device listing can be sorted based on any suitable criteria. For example, each device in the list can include an internal cost component data, for example the internal cost to the company to perform a particular document processing operations such as color printing. The device listing can be sorted by internal cost so to inform the user of costs and allow the user to make an informed selection from the selection list. In a configuration, the device listing can include devices owned by third parties, allowing the user to select third parties for performing document processing services. The device listing also can be sorted according to external costs, or show a combined listing of internal and external costs. For example, document processing operations provided by KINKOS or other third party providers can be listed in the device listing. In a configuration, when a third party device is selected for performing document processing services, payment to the third party provider can be provided through a payment window or similar function as would be understood by one of skill in the art.

In another embodiment, the device listing can be prioritized for service personnel based on service related criteria. For example, the device listing can be prioritized based on the anticipated time necessary to service each device. The device listing also can be prioritize based on the amount of time available to the service personnel, the distance between devices, and the best fit for maximizing the utility of the service personnel. In another example, the device listing can be based upon the availability of spare parts to particular service personnel. For example, spare parts can be carried by service personnel, locally available from a part depot, available from other local service personnel, or available for purchase at local stores. Spare parts necessary for servicing devices may need to be ordered and shipped to the location of the device or to the service personnel. The device listing can be integrated with the expected part arrival. In an embodiment, service call information can be transmitted to devices based on the expected arrival of the service personnel and/or expected part arrival. In a configuration, the devices in the device listing can receive updates based upon the position of each device in the technician's queue.

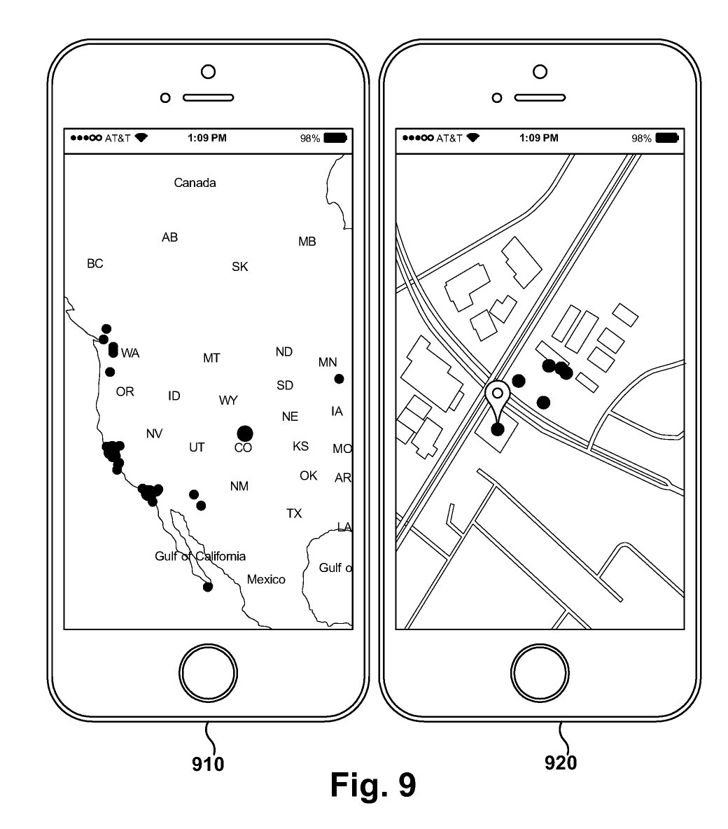

Turning now to FIG. 9, illustrated is an example embodiment of a mapping function associated with listed devices. Various scaling is suitably selected, with more distant scaling illustrated at interface 910 and a closer scaling illustrated at interface 920. Such mapping allows a user to quickly understand a location of devices for device administration, servicing or document processing job operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface configured for data communication with a plurality of identifiable multifunction peripherals,
the network interface configured to receive a remote device query from a portable data device associated with a remote device identifier and remote device location, and
the network interface configured to receive status data from each of the plurality of multifunction peripherals;
a processor and associated memory,
the memory configured to store data identifying a location of each of the multifunction peripherals, and
the processor configured to store received status data in the memory; and
an analytical engine, including the processor and memory, configured to calculate list data corresponding to an ordered set of the multifunction peripherals in accordance with stored status data and data identifying location of the multifunction peripherals,
wherein the processor is further configured to generate notifications corresponding to identified multifunction peripherals in accordance with an analysis of the list data, and
wherein the network interface is further configured to communicate the notifications to the portable data device in accordance with each identified multifunction peripheral and remote device identifier.

2. The system of claim 1 wherein the network interface is further configured to receive location data corresponding to a physical location of each of the multifunction peripherals,
wherein the processor is further configured to generate mapping data corresponding to relative locations of each of the multifunction peripherals identified by the location data,
wherein the processor is further configured to generate indicator data for mapped multifunction peripherals in accordance with the mapping data list data, and
wherein the processor is further configured to generate service area data corresponding to locations of each of the multifunction peripherals and indicator data associated therewith.

3. The system of claim 2 wherein the processor is further configured to generate service data corresponding to at least one device service area in accordance with the service area data, and further comprising:
an output configured to communicate the device service area to an associated technician.

4. The system of claim 3 wherein the network interface is further configured for receiving the status data comprising data associated with an error condition corresponding to at least one of the multifunction peripherals.

5. The system of claim 4 wherein the processor is further configured to generate alerts in accordance with data corresponding to preselected alert threshold.

6. The system of claim 3 wherein the network interface is further configured for receiving the status data comprised of machine environment data corresponding to a physical environment of at least one of the multifunction peripherals.

7. The system of claim 6 wherein the machine environment data is comprised of temperature data from a multifunction peripheral heat sensor.

8. A method comprising:
communicating data communication with a plurality of identifiable multifunction peripherals via an associated data network;
receiving a remote device query and device identifier from a portable data device;
receiving status data from each of the plurality of multifunction peripherals;
storing received status data in a memory;
calculating list data from stored status data in accordance with a received device query via an analytical engine including a processor and memory;
generating a notification corresponding to identified multifunction peripherals in accordance with an analysis of the list data; and
communicating the notification to the remote device in accordance with the device identifier.

9. The method of claim 8 further comprising:
receiving location data corresponding to a physical location of each of the multifunction peripherals via the data network;
generating mapping data corresponding to relative locations of each of the multifunction peripherals identified by the location data;
generating indicator data for mapped multifunction peripherals in accordance with the mapping data list data; and
generating service area data corresponding to locations of each of the multifunction peripherals and indicator data associated therewith.

10. The method of claim 9 further comprising:
generating service data corresponding to at least one device service area in accordance with the service area data; and
transmitting the device service area to an associated technician.

11. The method of claim 10 further comprising receiving the status data comprising data associated with an error condition corresponding to at least one of the multifunction peripherals.

12. The method of claim 11 further comprising generating the alerts in accordance with data corresponding to preselected alert threshold.

13. The method of claim 10 further comprising receiving the status data comprised of machine environment data corresponding a physical environment of at least one of the multifunction peripherals.

14. The method of claim 13 further comprising receiving the machine environment data is comprised of temperature data from a multifunction peripheral heat sensor.

15. A system comprising:
a network interface configured for data communication with a plurality of document processing devices, the network interface configured for ongoing receipt of event data from each document processing device;
a memory configured to store, for each document processing device, setup data specifying a device identifier, device location and designated service entity, the memory configured to store received event data; and
a processor configured to catalog received event into a plurality of categories event data in accordance with characteristics thereof and timing data indicative of a duration between events associated with a single document processing device of the plurality thereof,
the processor configured to generate list data indicative of device failure rates accordance with one or more cataloged events and associated timing data,
the processor configured to apply the list data to the event data for each of the plurality of documents processing device to calculate a likelihood of failure factor for each device,
the processor configured to generate document processing device clusters comprising a geographically-proximate grouping of document processing devices in accordance the failure factors, and
the processor configured to communicate data corresponding to the device clusters and data corresponding to a calculated likelihood of failure to a commonly associated service entity.

16. The system of claim 15 wherein the network interface is further configured for data communication with device logs from each of the plurality of document processing devices, and wherein the status data is comprised of information from the device logs.

17. The system of claim 16 wherein the network interface is further configured for data communication with a sensor from each of the plurality of document processing devices, and wherein the status data is comprised of information from the sensors.

18. The system of claim 17 wherein the sensor is comprised of a paper document counter.

19. The system of claim 18 wherein the network interface is further configured for data communication with a portable, personal data device, and wherein the status data is comprised of user-supplied device data.

20. The system of claim 19 wherein the processor is further configured to communicate the data corresponding to the device clusters and corresponding to a calculated likelihood of failure to the commonly associated service entity when the likelihood of failure exceeds a preselected threshold value.
